(19) United States
(12) Patent Application Publication
(10) Pub. No.: US 2008/0205198 A1
(43) Pub. Date: Aug. 28, 2008

(54) Adjustable time relating device for non-readers

(76) Inventors: Russell Sherman, Westport, CT (US); Alex Sherman, Westport, CT (US)

Correspondence Address: Mark A. Litman & Associates, P.A.;York Business Center, Suite 205, 3209 West 76th St., Edina, MN, 55435, US

(21) Appl. No.: 11/712,248

(22) Filed: Feb. 28, 2007

(51) Int. Cl. G04C 15/00

(52) U.S. Cl. 368/62

(57) ABSTRACT

A viewable time piece has a face from which relative time is read. The time piece has a changeable time indicator. Symbol or image changes on the time indicator are effected by placement or replacement of at least some non-alphanumeric symbols for view that are indicative of various events over the course of a day. The time piece allows exchange and replacement of the non-alphanumeric symbols so that different events may be indicated for similar respective times over the course of a day. There may also be a system that provides time variant changes in the symbols that are displayed over the course of the day.

### BACKGROUND OF THE INVENTION

1. Field of the Invention

The present technology relates to time-relating devices, such as clocks, especially clocks with images or images and numbers identified by moving hands or panels, and clocks with adjustable images that may be associated with times to allow persons, and especially young persons to identify time of day and tasks according to at least one of symbols and symbols and numbers.

2. Background of the Art

There are numerous types of time-indicating devices available to the public. The most traditional device is the standard clock with a circular pattern on a face with usually 12 numbers thereon in even spacing around the face. Pointers (hands) are rotated about the face to indicate hours of the day with one hand and minutes of the day with another, with the movement of hands coordinated around the face of the clock. Second hands may also be provided. The use of electronic systems enabled seven-digit displays of hours, minutes, seconds and even portions of seconds (e.g., tenths, hundredths, etc.) to be displayed. Panels may also be used, with separate panels being exposed to show hours (1-12 or 1-24), minutes (0-59) and days to a viewer.

There is sufficient complexity to the reading of traditional circular face clocks that the task is taught in school and has been part of intelligence tests provided to the public.

The task of reading traditional round-face clocks with moving hands is especially difficult for pre-school-age children and other young children, and even older persons who have or have developed recognition disorders or learning disorders or associative disorders. These difficulties reduces the ability of the individuals to function on a daily basis and can create problems for others, such as family or care-givers, when the individuals cannot perform rudimentary tasks at certain times of the day, or who are impatient for events and do not have a basis for associating those events for particular times of the day.

Some children's clocks are known to have pictures and images on their faces such as animals, the sun, the moon, flowers and the like, and these images are fixed and painted/printed onto the face for decorative and amusement purposes.

### SUMMARY OF THE INVENTION

A clock face is provided with changeable images that may be associated with general or specific times of the day, and at least some images may particularly designate or represent events or tasks that are to be accomplished at desired times or time frames. For example, an image of a child resting on a pillow may be inserted at 10 a.m. or 2 p.m. (or other targeted time) so that when the clock indicates that time, anyone viewing the clock will see that it is also nap time. Different images may be placed at different time positions, either by electronic images being activated or by reels or inserts or other physical means for inserting a picture or image. More than one image may appear at each time position. The clocks need not be so precise as to display hours, minutes and seconds, but may display only hours or minutes or only hours along with the images. It is also possible to have the clock display only the images. It is desirable to additionally provide some indication of minutes is accurate timing is desired, although extrapolation between images can be used for reasonably accurate approximations, and, alternatively, the clock can be set automatically using the atomic clock in Colorado or by accessing radio signals, broadcast signals, telephone signals, or other wireless or wired signals (e.g., through a computer on a phone modem).

### BRIEF DESCRIPTION OF THE FIGURES

FIG. 1 shows adjacent panels that may be used in a flip clock or as an adjacent time/symbol set in a round face clock with hand(s), the symbol indicating a sun for wake-up time or outdoor time.

FIG. 2 shows adjacent panels that may be used in a flip clock or as an adjacent time/symbol set in a round face clock with hand(s), the symbol indicating

FIG. 3 shows adjacent panels that may be used in a flip clock or as an adjacent time/symbol set in a round face clock with hand(s), the symbol indicate

FIG. 4 shows adjacent panels that may be used in a flip clock or as an adjacent time/symbol set in a round face clock with hand(s), the symbol indicating

FIG. 5 shows adjacent panels that may be used in a flip clock or as an adjacent time/symbol set in a round face clock with hand(s), the symbol indicating 9 o'clock (during daylight hours) and a specifically identified pill that should be taken at that time of day.

FIG. 6 shows a front view of a clock with a complete face and stand arrangement with user inputs.

### DETAILED DESCRIPTION OF THE INVENTION

A clock face (either as a round clock face, mechanical face, electronic display face, or the like) is provided with changeable or replaceable images that may be associated with general or specific positions or symbols indicating times of the day, and at least some images may particularly designate or represent events or tasks that are to be accomplished at desired times or time frames.

The clock face may be a traditional round face with hands, a round face with electronic displays of numbers, an entirely electronic display of time indicators and symbols, symbols and optionally hands, a digital clock with panels or frames adjacent each other for at least hours and a symbol or even just a symbol, a mechanical panel clock with dropping panels of time indications and symbols or only symbols), and any other electronic and/or mechanical device that can have a display of time and an associated symbol, wherein the symbol can be changed at the control of a user.

The replacement of symbols may be done electronically through stored memory (which may optionally be writeable, so that personal images may be downloaded and displayed) or by mechanical means, such as reels that may be rotated (vertically or horizontally with respect to the plane of the face) to display images and/or with tab inserts that may be inserted in areas adjacent to or otherwise associated with positions on the clock indicating relative or actual time. If the clock face is transparent or translucent, for example, the numbers (if any) may be seen over or under symbol images, which also may be translucent or transparent, and tabs or slips with images on them may be physically inserted into the clock to change the implication of the time. Images may also be projected on the ceiling or wall through a projection imaging system associated with the clock. The projection system may be as simple as a shadow casting light, with moving alternative shadowing mask images, or may have slides that move across the display. The images may move in a rapid transition to the display upon attaining specific times on the clock and may be projected for predetermined (e.g., manually set) periods of time. The images or symbols may also be handwritten or drawn onto slides by the user with erasable or permanent pigment or other material.

Image sets (on cards or via websites can be purchased. Licensing agreements with content providers will enable users to buy images using characters from television shows, sports teams, etc.

The technology described herein may comprise a time piece and a method of using a timepiece. A non-limiting description of this technology may be represented by A viewable time piece comprising a face from which relative time is read, the time piece comprising: a changeable time indicator; changes on the time indicator comprising placement or replacement of non-alphanumeric symbols for view that are indicative of various events over the course of a day; the time piece allowable exchange and replacement of the non-alphanumeric symbols so that different events may be indicated for similar respective times over the course of a day; and a system that provides time variant changes in the symbols over the course of the day. The time piece may comprise an electronic clock with virtual images provided on the face from a stock of selectable files of images or a mechanical clock with at least one moving hand and images provided on the face from a stock of selectable images that may be inserted for view within the face. A light projection system may be provided in the time piece for casting images related to symbols being displayed as indicative of the various events. These images may be special characters or images that are viewed as rewards, such as a comic book or cartoon character, or an image of a pet or person. For example, the time piece may have files of at least symbols relating to a task selected from the group consisting of medicine taking, room-cleaning, tooth-brushing, saying prayers, completing identified work and reading, and the image indicative of task completion can be activated only when these symbols have been displayed. That is, when the user input button is pushed while a symbol for a snack is displayed, the reward image will not be displayed. This will prevent a child from merely pressing the button by herself or himself to see the image. The time piece may be allowed to display more than one symbol at a time, which can be effected by positioning more than one symbol at a specific relative time position on the face. The time piece may further comprise a projection system that projects light through an area wherein slides can be supported and either shadow images or transmitted images on the slides can be projected. The user may place regular slides or hand decorated slides into the projection area for the display.

The images displayed may vary according to the intentions of the user in providing information to a recipient of the images. For example, meal times may be displayed with a baby bottle, breakfast image (e.g., eggs/bacon/toast), lunch image (e.g., soup/sandwich image), snack image (e.g., fruit/cheese/crackers/roll image) and dinner image (e.g., fish/meat/vegetables/salad image); medication time may be indicated with a medicine bottle, pill box, spoon or pills' image; play time may be indicated by a swing, maze, balls, trampoline, doll, truck or other toy image; nap time may be indicated with an image of a head resting against a pillow or a bed; reading time may be displayed by a book; bedtime may be displayed by an image of a bed and a moon; wake-up time may be displayed by a sun image or a washroom or a person dressing; etc. With the image of a pill box, for example, the pill box itself may have the same image displayed to simplify the cross-reference. Many other associative images may be provided. Such images may appear directly on the face of the clock or be projected by the clock onto another surface like a wall.

It is also possible, where desired, to provide an alarm function for some or all of the images, where the time is actually important. For example, with seniors who may be having difficulty in remembering times to take specific medications, the clock may not only have an alarm to indicate that something should be taken, but there may be an image presented that a specific medication should be taken, such as an image of the medication and/or some symbol clearly identifying the medication. In this way, the alarm identifies the medication in a way that simplifies taking the proper material by providing an image of the medication.

There may be more than one image corresponding to a specific time that is stored in clock and which may be separately or concurrently displayed. A button on the clock could be used to toggle between two images so for example if the image indicated a pill is to be taken at a specific time the user could press a button after taking the pill and the image would change to a smiley face indicating the pill had been taken. If desirec the clock. It is also possible, where desired, to provide a voice annunciation or other time of sound generation device so that the clock can announce or indicate the desired activity.

Other examples might be an image of a child resting on a pillow may be inserted at 10 a.m. or 2 p.m. (or other targeted time) so that when the clock indicates that time, anyone viewing the clock will see that it is also nap time. Different images may be placed to correspond with different time positions, either by electronic images being activated or by reels or inserts or other physical means for inserting a picture or image. The clocks need not be so precise as to display hours, minutes and seconds, but may display only hours or minutes or only hours along with the images. It is also possible to have the clock display only the images.

As noted, a memory chip (writeable or not, removable or not) and accessible via any I/O port such as USB port, wifi, cables, Bluetooth or other may be provided with images thereon for electronic systems. By a simple process such as engaging a change image function and moving to a particular time position on the clock, a menu of images can be reviewed and a particular image inserted by user entry. However, it is not necessary that there be a menu. In ‘set’ mode the user can cycle through hours and images and when the correct image is displayed with the correct hour the user can hit the ‘synch’ button to set the image and hour to correspond with each other.

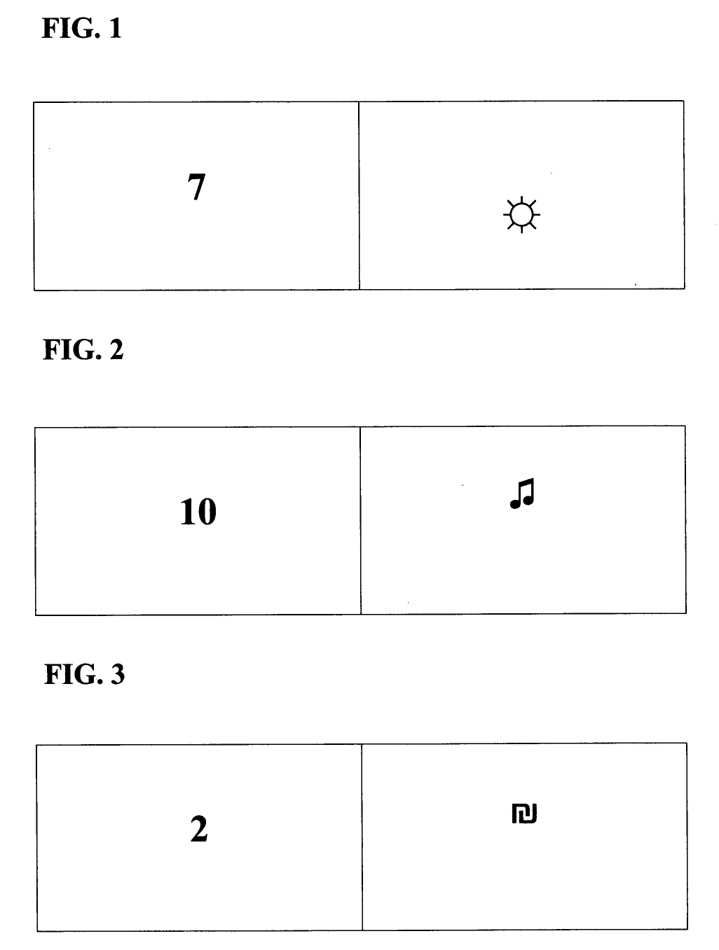

FIG. 1 shows adjacent panels that may be used in a flip clock or as an adjacent time/symbol set in a round face clock with hand(s), the symbol indicating a sun for wake-up time or outdoor time. The images can also be projected on the wall or ceiling.

FIG. 2 shows adjacent panels that may be used in a flip clock or as an adjacent time/symbol set in a round face clock with hand(s), the symbol indicating

FIG. 3 shows adjacent panels that may be used in a flip clock or as an adjacent time/symbol set in a round face clock with hand(s), the symbol indicate

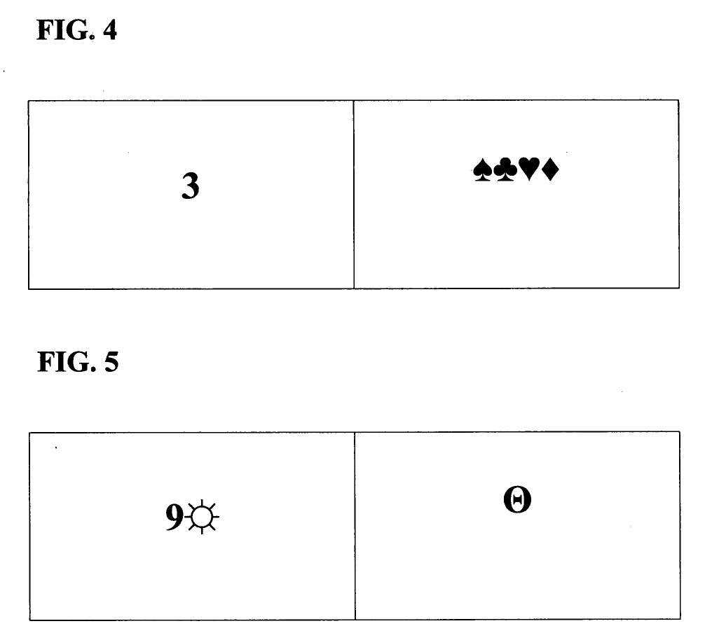

FIG. 4 shows adjacent panels that may be used in a flip clock or as an adjacent time/symbol set in a round face clock with hand(s), the symbol indicating

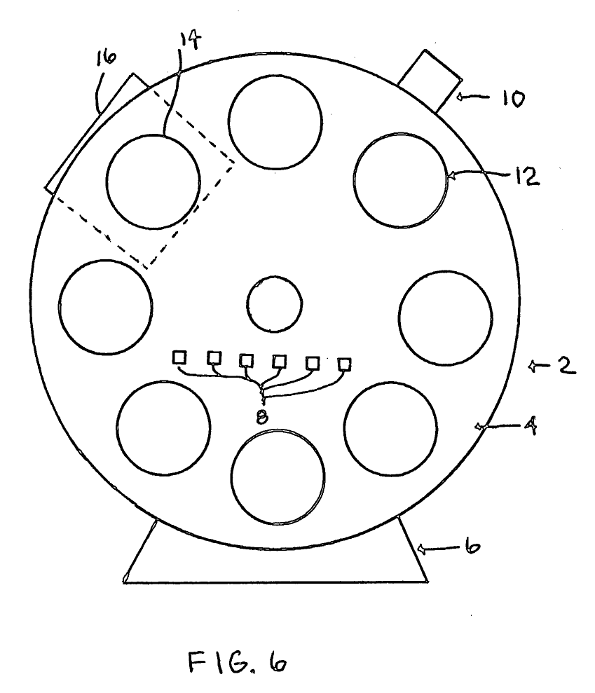

FIG. 5 shows adjacent panels that may be used in a flip clock or as an adjacent time/symbol set in a round face clock with hand(s), the symbol indicating 9 o'clock (during daylight hours) and a specifically identified pill that should be taken at that time of day.

FIG. 6 shows a front view of a clock 2 with a complete face 4 and stand 6 arrangement with user inputs 8 and 10. User inputs 8 may be for selecting from among files of images stored in memory and directing display of individual or multiple files (at the same time or in sequence) in a single display area 12, for example. A second mode of image display on the face 4 or for projection is shown in image display area 14 wherein a slide 16 is shown inserted into the clock 2 to provide a preselected or even hand drawn image. The user input 10 may be the reward activation input discussed earlier herein, wherein the input 10 may be activatable only when a particular symbol is shown in a particular frame (e.g., 12). The user input 10 may activate the reward in one or more of the shown display areas, in a static mode (still image) or a progression, sequence or storyline in one or more display areas.

In addition to the visual technology that has been described above for providing task information and task symbols to a user, it is possible to additionally have audio information available that supplements the symbol and/or image display, either as a task indicator or as a reward. For example, the clock may have an audio recording capability which would allow the user to record messages for corresponding times or events. For instance a mother could record a message wishing a child good morning at 7:00 am (great for when she ships him off to summer camp) or a guardian doctor could remind a patient to take a certain medication at a certain time. The use of semiconductor or other solid state recording systems as opposed to a magnetic tape system would be preferred.

Although specific examples of structures and methods have been provided herein, these specific examples are intended to be disclosure of species enabling a generic concept of the technology and the claims should be interpreted accordingly.

What is claimed:

1. A viewable time piece comprising a face from which relative time is read, the time piece comprising:
a changeable time indicator;
changes on the time indicator comprising placement or replacement of non-alphanumeric symbols for view that are indicative of various events over the course of a day;
the time piece allowable exchange and replacement of the non-alphanumeric symbols so that different events may be indicated for similar respective times over the course of a day; and
a system that provides time variant changes in the symbols over the course of the day.

2. The time piece of claim 1 comprising an electronic clock with virtual images provided on the face from a stock of selectable files of images.

3. The time piece of claim 1 comprising a mechanical clock with at least one moving hand and images provided on the face from a stock of selectable images that may be inserted for view within the face.

4. The time piece of claim 1 wherein a light projection system is provided in the time piece for casting images related to symbols being displayed as indicative of the various events.

5. The time piece of claim 2 wherein a light projection system is provided in the time piece for casting images related to symbols being displayed as indicative of the various events.

6. The time piece of claim 3 wherein a light projection system is provided in the time piece for casting images related to symbols being displayed as indicative of the various events.

7. The time piece of claim 2 also comprising a user input that may be used to provide an image indicative of task completion after a specific various event displayed on a symbol has been completed.

8. The time piece of claim 7 wherein the time piece has files of at least symbols relating to a task selected from the group consisting of medicine taking, room-cleaning, tooth-brushing, saying prayers, completing identified work and reading, and the image indicative of task completion can be activated only when these symbols have been displayed.

9. The time piece of claim 7 wherein the time piece has files of at least symbols relating to a task selected from the group consisting of medicine taking, room-cleaning, tooth-brushing, saying prayers, completing identified work and reading, and the image indicative of task completion comprise at least one special image or a sequence of images that can be displayed only when these symbols relating to a task have been displayed.

10. The time piece of claim 1 wherein more than one symbol may be positioned at a specific relative time on the face.

11. The time piece of claim 2 wherein more than one symbol may be positioned at a specific relative time on the face.

12. The time piece of claim 4 wherein the projection system projects light through an area wherein slides can be supported and either shadow images or transmitted images on the slides can be projected.

13. The time piece of claim 1 wherein a voice recording system is present in the time piece and recorded messages are broadcast along with related symbols or images.

14. The time piece of claim 2 wherein the files are stored in ROM within the time piece.

15. The time piece of claim 2 wherein the files are stored in writeable and erasable memory within the time piece.

16. The time piece of claim 4 wherein a storage bin is present on the time piece with transparent slides in the storage bin.
